(19) United States
(12) Patent Application Publication
(10) Pub. No.: US 2020/0122606 A1
(43) Pub. Date: Apr. 23, 2020

(54) APPARATUS AND SEAT ASSEMBLY TO PREVENT UNINTENDED SEAT ADJUST SWITCH ACTUATION IN VEHICLE SIDE IMPACT

(71) Applicant: FORD GLOBAL TECHNOLOGIES, LLC, Dearborn, MI (US)

(72) Inventors: Juergen Koehler, Köln (DE); Linh Ngoc Doan, Belleville, MI (US)

(21) Appl. No.: 16/162,629

(22) Filed: Oct. 17, 2018

(51) Int. Cl. B60N 2/02; H01H 15/10

(52) U.S. Cl. CPC B60N 2/0228; H01H 2300/024; H01H 15/10

(57) ABSTRACT

An apparatus adapted to prevent unintended seat adjust switch actuation in a vehicle side impact or crash includes a wall, having a window, a seat adjustment switch behind the wall, an actuator connected to the seat adjustment switch and extending through the window and a stop adapted to limit displacement of the actuator when the actuator is displaced inboard toward the wall. That stop may be carried on one of the wall or the actuator. A new and improved seat assembly is also disclosed.

### TECHNICAL FIELD

This document relates generally to the motor vehicle equipment field and, more particularly, to a new and improved apparatus and seat assembly configured or adapted to prevent unintended seat adjust switch actuation as a result of a vehicle side impact.

### BACKGROUND

As illustrated in FIG. 1A, it is relatively common practice to provide a seat adjustment switch S and associated actuator AC on the outboard wall W of a seat near the door trim panel P. That actuator AC may be displaced in either direction (note action arrows A) in order to adjust the position of the seat. As illustrated in FIG. 1B, during a side impact event (note action arrow B), the door trim panel P may be deformed vehicle inward to a convex shape. If the side impact is of sufficient force, this may result in the door trim panel P engaging the seat adjustment switch actuator AC. As illustrated in FIG. 1B, that intrusion and shape may inadvertently displace the seat adjustment switch actuator AC in the direction of action arrow C thereby actuating and moving the seat forward closer to the steering wheel: an unintended and potentially problematic consequence of the vehicle side impact.

This document relates to a new and improved apparatus and a new and improved seat assembly configured and adapted to prevent unintended seat adjustment switch actuation in the event of a vehicle side impact or side crash causing the door trim panel to intrude inboard toward the seat adjustment switch actuator.

### SUMMARY

In accordance with the purposes and benefits as described herein, a new and improved apparatus is provided. That apparatus comprises (a) an outboard seat shield or wall including a window, (b) a seat adjustment switch inboard of that wall, (c) an actuator, outboard of that wall, connected to the seat adjustment switch and (d) a stop adapted to limit displacement of the actuator when the actuator is displaced inboard toward the wall wherein the stop is carried on one of the wall and the actuator.

The actuator may include a stem and a knob. That stem may have a proximal end connected to the seat adjustment switch and a distal end connected to the knob.

In one possible embodiment of the apparatus, the stop is located on the actuator adjacent an intersection of the knob and the stem. That stop may comprise (a) a first shoulder and (b) a second shoulder on an opposite side of the stem from the first shoulder. In other possible embodiments, that stop may comprise a continuous step extending around the stem. In still other possible embodiments the stop may comprise a first set of opposed shoulders and a second set of opposed shoulders wherein the first set of opposed shoulders is substantially perpendicular to the second set of opposed shoulders.

In still another possible embodiment the stop is located on the wall adjacent the window. In such an embodiment the stop may comprise (a) a first shoulder and (b) a second shoulder on an opposite side of the window from the first shoulder. In other such embodiments the stop may comprise a continuous step extending around the window. In still other possible embodiments the stop may comprise a first set of opposed shoulders and a second set of opposed shoulders wherein the first set of opposed shoulders is substantially perpendicular to the second set of opposed shoulders.

In accordance with an additional aspect, a new and improved seat assembly is provided. That new and improved seat assembly comprises a seat in conjunction with the apparatus described above. Thus the seat assembly may include a seat, a wall carried on the seat, that wall including a window, a seat adjustment switch inboard of the wall, an actuator, outboard of the wall, connected to the seat adjustment switch and a stop adapted to limit displacement of the actuator when the actuator is displaced inboard toward the wall wherein the stop is carried on one of the wall and the actuator.

As noted above the actuator may include a stem and a knob. That stem may have a proximal end connected to the seat adjustment switch and a distal end connected to the knob. In some embodiments the stop may be located on the actuator adjacent an intersection of the knob and the stem. In other embodiments the stop may be located on the wall adjacent the window.

In either of these embodiments the stop may comprise (a) a first shoulder and (b) a second shoulder on an opposite side of the stem from the first shoulder. In still other possible embodiments the stop may comprise a continuous step extending around the stem. In still other embodiments the stop may comprise a first set of opposed shoulders and a second set of opposed shoulders wherein the first set of opposed shoulders is substantially perpendicular to the second set of opposed shoulders.

In still other embodiments the stop may comprise a first shoulder and a second shoulder on an opposite side of the window from the first shoulder. In still other embodiments the stop may comprise a continuous step extending around the window. In still other embodiments the stop may comprise a first set of opposed shoulders and a second set of opposed shoulders wherein the first set of opposed shoulders is substantially perpendicular to the second set of opposed shoulders on opposite sides of the window.

In the following description, there are shown and described several preferred embodiments of the apparatus and the seat assembly. As it should be realized, the apparatus and the seat assembly are capable of other, different embodiments and their several details are capable of modification in various, obvious aspects all without departing from the apparatus and seat assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and the seat assembly and together with the description serve to explain certain principles thereof.

FIG. 1A is a schematic cross-sectional view of a prior art seat adjustment switch illustrated in full line in the home or rest position and in phantom line in two active seat adjustment positions.

FIG. 1B is a view of the prior art similar to FIG. 1A but showing the intrusion of the door trim panel due to a side impact resulting in engagement of the seat actuator and displacement of the seat actuator forward thereby actuating seat movement toward the steering wheel of a motor vehicle.

FIG. 2 is a perspective view of a new and improved seat assembly incorporating the new and improved apparatus configured or adapted to prevent unintended seat adjust switch actuation in the event of a vehicle side impact or crash causing intrusion of the door trim panel.

FIGS. 3A and 3B are respective schematic cross sectional views of the apparatus showing an alternative embodiment thereof wherein the stop is carried on the actuator. FIG. 3A illustrates the actuator, prior to a side impact, in full line in the rest position and in phantom line in the two active seat adjustment positions. In contrast, in FIG. 3B, the door trim panel has been displaced by a side impact into engagement with the actuator and a stop on the actuator has limited and prevented displacement of the actuator into an active seat adjustment position.

FIGS. 4A-4C illustrate in detail multiple embodiments of the actuator with integral stop. In FIG. 4A, the stop comprises first and second shoulders on opposite sides of the stem of the actuator. In FIG. 4B the stop comprises a continuous step extending around the stem. In FIG. 4C, the stop comprises a first set of opposed shoulders and a second set of opposed shoulders wherein the first set of opposed shoulders is substantially perpendicular to the second set of opposed shoulders at the intersection of the stem and the knob of the actuator.

FIGS. 5A and 5B are schematic cross sectional views of the new and improved apparatus. More particularly, FIG. 5A illustrates the apparatus prior to a side impact event with the actuator shown in full line in the rest position and in phantom line in the two active seat adjustment positions. In contrast, in FIG. 5B, the door trim panel has been displaced by a side impact into engagement with the actuator and a stop on the wall has limited and prevented displacement of the actuator into an active set adjustment position.

FIG. 6A is a detailed side elevational view illustrating a first possible embodiment of the stop in the form of two opposed shoulders provided in the seat shield or wall at opposite ends of the window.

FIG. 6B is a detailed elevational view of yet another possible embodiment of the stop wherein the stop comprises a continuous step extending around the window in the seat shield or wall.

FIG. 6C is a view similar to FIGS. 6A and 6B but illustrating yet another possible embodiment of stop wherein the stop comprises a first set of opposed shoulders and a second set of opposed shoulders wherein the first set of opposed shoulders is substantially perpendicular to the second set of opposed shoulders along the four sides of the window in the seat shield or wall.

Reference will now be made in detail to the present preferred embodiments of the apparatus and seat assembly, examples of which are illustrated in the accompanying drawing figures.

### DETAILED DESCRIPTION

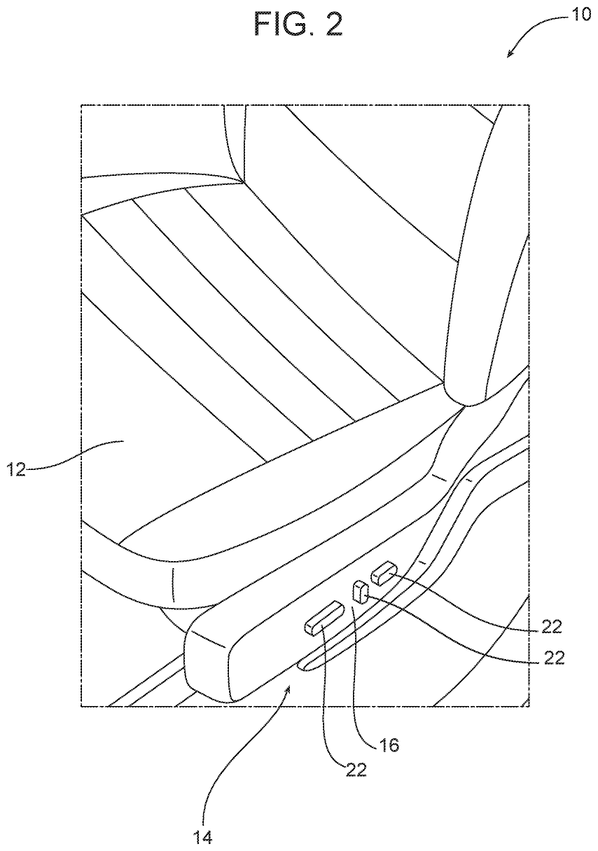

Reference is now made to FIG. 2 illustrating a new and improved seat assembly 10 incorporating a seat 12 and an apparatus 14 configured or adapted to prevent unintended seat adjustment switch actuation in the event of a side impact or side crash. As illustrated in FIG. 2, the apparatus 14 includes a seat side shield or wall 16 and a plurality of actuators 22 by which an operator may adjust the position of the seat 12.

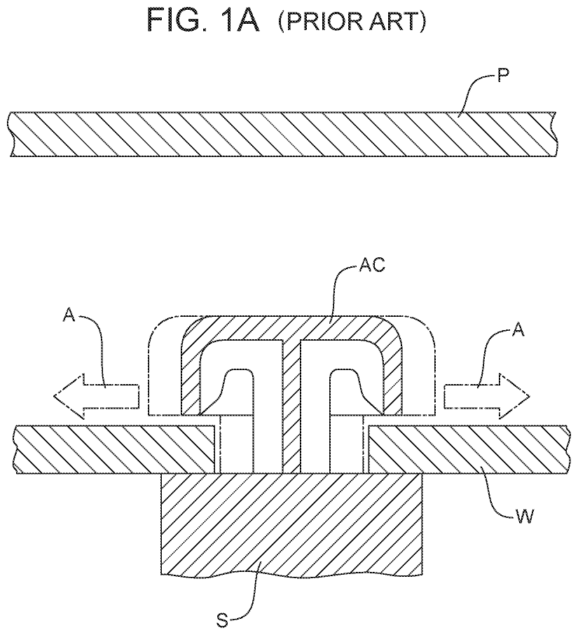

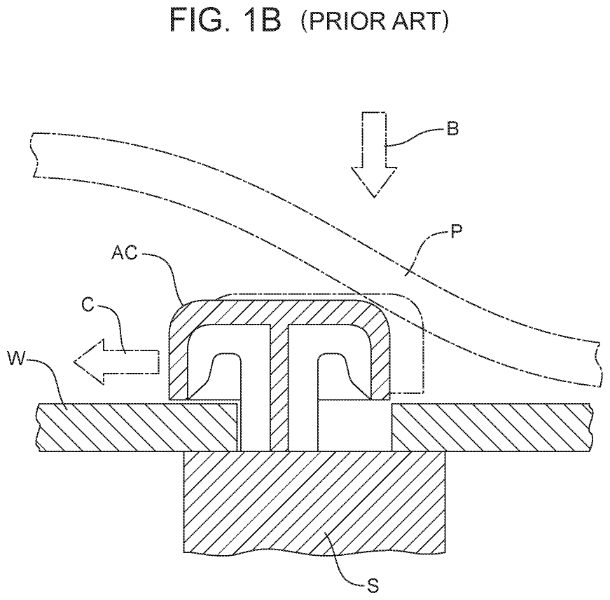

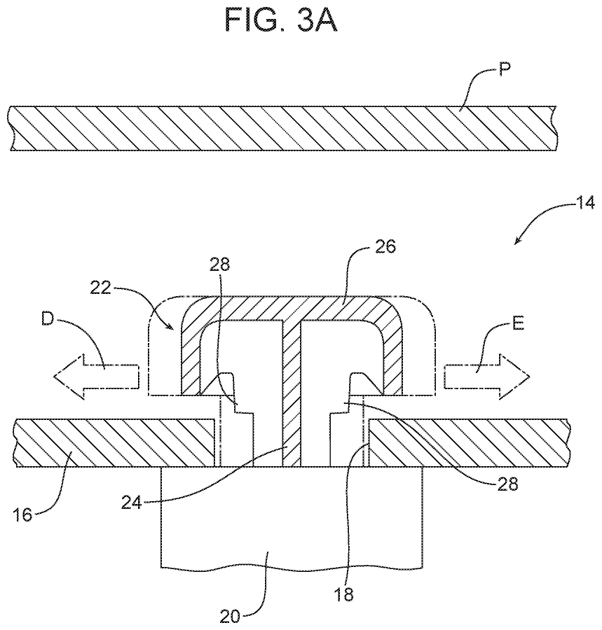

One possible embodiment of the apparatus 14 is illustrated in FIGS. 3A and 3B. As shown in those Figures, the apparatus 14 includes a sheet side shield or wall 16 that extends along or by an outboard side of the seat 12 (see FIG. 1). The wall 16 includes a window 18.

A seat adjustment switch 20 is positioned behind or inboard the wall 16 adjacent the window 18. An actuator 22, outboard of the wall 16, is connected to the seat adjustment switch 20. In the illustrated embodiment, the actuator 22 includes a stem 24 and a knob 26. More particularly, the stem 24 has a proximal end connected to the seat adjustment switch 20 and a distal end connected to the knob 26.

As further illustrated in FIGS. 3A and 3B, the apparatus 14 also includes a stop 28. The stop 28 is adapted to limit displacement of the actuator 22 when the actuator is displaced inboard toward the wall 16 by intrusion of and contact with the door trim panel P as may result from a side impact or crash. In the embodiment illustrated in FIGS. 3A and 3B, the stop 28 is located on the actuator 22 adjacent to the intersection of the knob 26 and the stem 24.

FIG. 3A illustrates the actuator 22 in full line in the normal or home position. In this position the seat adjustment switch 20 is deactivated and no seat adjustment is provided. If one wishes to adjust the seat 12 forward, one displaces the actuator 22 in the direction of action arrow D into the phantom line position shown to the left of the actuator in FIG. 3A. In contrast, if one wishes to displace the seat 12 rearward, one displaces the actuator 22 in the direction of action arrow E into the phantom line position toward the right of the actuator 22. Note that in the normal operating position illustrated in FIG. 3A, the stop 28 will not engage the edges 30 of the wall 16 defining the ends of the window 18 thereby allowing free movement to the two active seat adjustment positions illustrated in phantom line in FIG. 3A.

As illustrated in FIG. 3B, when the door trim panel P has been displaced by an impact force F so as to intrude toward and into engagement with the knob 26 of the actuator 22, the actuator 22 is likewise displaced inward toward the wall 16. In this displaced position, the stop 28 on the stem 24 engages the edge 30 of the wall 16 defining the window 18 thereby preventing full sliding movement of the actuator into the active seat adjustment position and thus preventing unintended seat adjustment switch actuation as a result of the side impact.

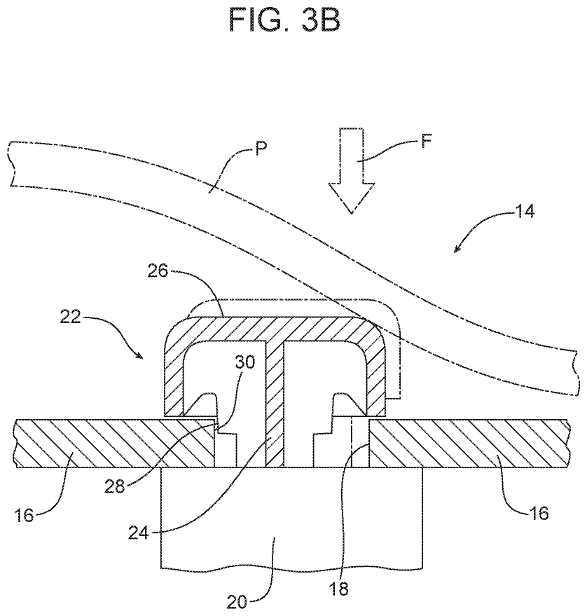

FIGS. 4A, 4B and 4C illustrate in detail three possible configurations for the stop 28. These three possible embodiments should be considered as illustrative in scope and not restrictive: that is, the stop 28 may assume other, different configurations.

In FIG. 4A, the stop 28 comprises a first shoulder 32 at a first side of the stem 24 and a second shoulder 34 at a second side of the stem. As illustrated in FIG. 4A, the first shoulder 32 and the second shoulder 34 are aligned with a range of movement of the actuator 22 along the axis A₁ allowing fore or aft adjustment of the seat 12.

In FIG. 4B, the stop 28 comprises a continuous step 36 extending completely around the stem 24.

In FIG. 4C, the stop 28 comprises a first set of opposed shoulders 38 and a second set of opposed shoulders 40 wherein the first set of opposed shoulders is substantially perpendicular to the second set of opposed shoulders adjacent the stem 24. In the embodiment illustrated in FIG. 4C, the first set of opposed shoulders 38 are provided along the axis A₁ while the second set of opposed shoulders are provided along the axis A₂. Movement of the actuator along the axis A₁ may provide for raising and lowering adjustment of the seat 12 while movement of the actuator along axis A₂ may provide for fore and aft adjustment of the seat 12. In this embodiment, the two sets of opposed shoulders 38, 40 would prevent actuation of the seat adjustment switch 20 and displacement of the seat 12 in any of these directions in the event the intrusion of the door trim panel P tended to force the actuator 22 in a direction to activate the seat adjustment switch and cause such displacement.

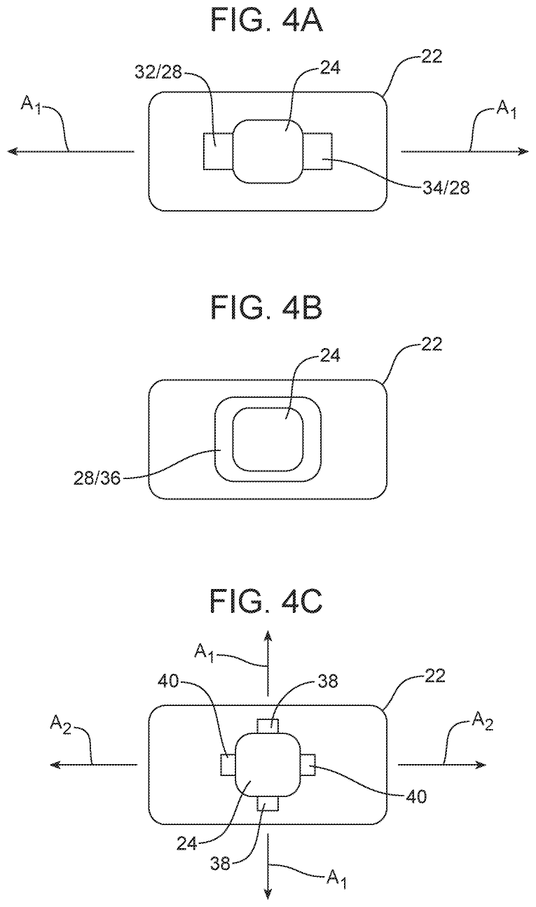

Reference is now made to FIGS. 5A and 5B illustrating an alternative embodiment of the apparatus 14 wherein the stop 28 is carried on the wall 16 at the window 18.

More particularly as illustrated in FIGS. 5A and 5B, the stop 28 comprises a first shoulder 42 at a first end of the window 18 and a second shoulder 44 at a second, opposite end of the window 18. FIG. 5A illustrates the actuator 22 in full line in the normal home or rest position. In this position the actuator 22 may be displaced in the direction of action arrow G to displace the seat forward and in the direction of action arrow H to displace the seat rearward.

As illustrated in FIG. 5B, the force of a side impact (note action arrow F) has caused intrusion of the door trim panel P which engages the actuator 22 causing displacement of the actuator in the direction of action arrow I toward the wall 16 and also in the direction action arrow G forward until the actuator side 46 of the knob 26 engages the shoulder 42 preventing further displacement of the actuator 22 into an active seat adjustment position. As a result, unintended seat adjustment switch actuation is prevented.

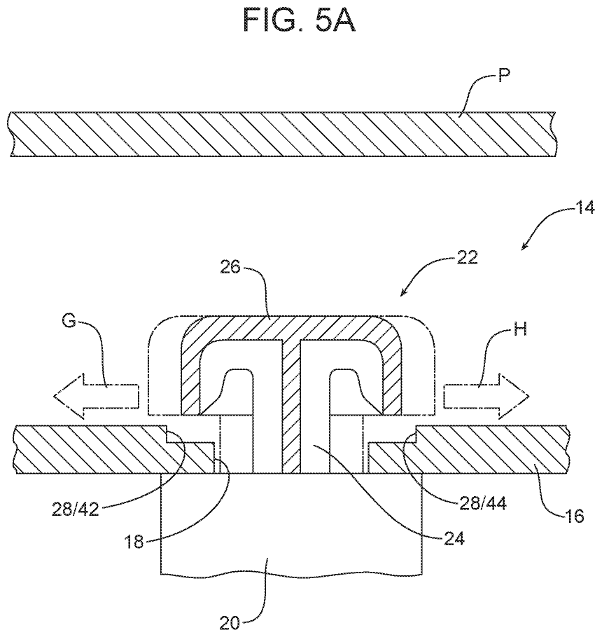

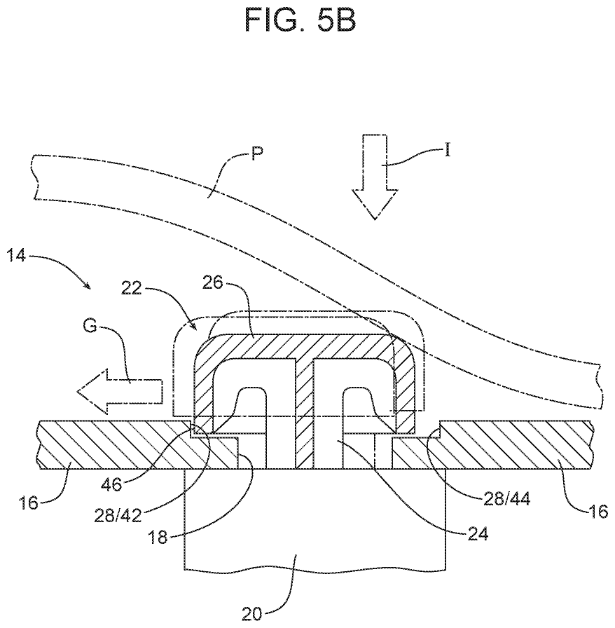

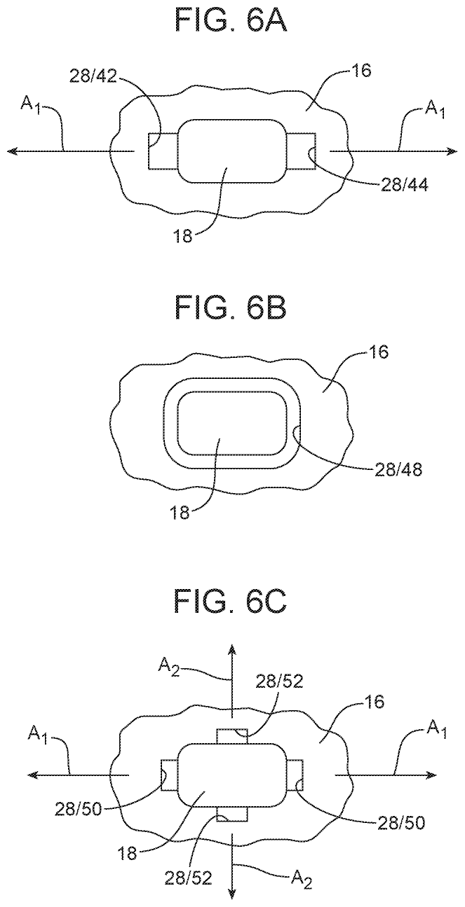

FIGS. 6A, 6B and 6C illustrate three possible embodiments of the stop 28 illustrated in FIGS. 5A and 5B. Once again, these possible embodiments should be considered as illustrative in nature and not as restrictive.

In FIG. 6A, the stop 28 comprises the first shoulder 42 and the second shoulder 44 at opposite sides or ends of the window 18 and aligned along the axis A₁ allowing for displacement of the actuator 22 to move the seat 12 in a fore or aft direction.

In FIG. 6B, the stop 28 takes the form of a continuous step 48 extending completely around the window 18 in the wall 16.

In FIG. 6C, the stop 28 comprises a first set of opposed shoulders 50 at two opposing ends of the window 18 aligned along the axis A₁ (allowing for fore/aft seat adjustment) and a second set of opposed shoulders 52 at two opposed ends of the window 18 along a second axis A₂ (allowing for raising and lowering of the seat). In such an embodiment, when the door trim panel P intrudes sufficiently to engage the actuator 22 and displace the actuator inward toward the wall 16 so that the knob 26 engages one of the shoulders of the first set of opposed shoulders 50 and second set of opposed shoulders 52, any unintended seat adjust switch actuation and seat displacement is prevented.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An apparatus, comprising:
a wall including a window;
a seat adjustment switch inboard of said wall;
an actuator outboard of said wall connected to said seat adjustment switch; and
a stop adapted to limit displacement of said actuator when said actuator is displaced inboard toward said wall wherein said stop is carried on one of said wall and said actuator.

2. The apparatus of claim 1, wherein said actuator includes a stem and a knob.

3. The apparatus of claim 2, wherein said stem has a proximal end connected to said seat adjustment switch and a distal end connected to said knob.

4. The apparatus of claim 3, wherein said stop is located on said actuator adjacent an intersection of said knob and said stem.

5. The apparatus of claim 4, wherein said stop comprises (a) a first shoulder and (b) a second shoulder on an opposite side of said stem from said first shoulder.

6. The apparatus of claim 4, wherein said stop comprises a continuous step extending around said stem.

7. The apparatus of claim 4, wherein said stop comprises a first set of opposed shoulders and a second set of opposed shoulders wherein said first set of opposed shoulders is substantially perpendicular to said second set of opposed shoulders.

8. The apparatus of claim 3, wherein said stop is located on said wall adjacent said window.

9. The apparatus of claim 8, wherein said stop comprises (a) a first shoulder and (b) a second shoulder on an opposite side of said window from said first shoulder.

10. The apparatus of claim 8, wherein said stop comprises a continuous step extending around said window.

11. The apparatus of claim 8, wherein said stop comprises a first set of opposed shoulders and a second set of opposed shoulders wherein said first set of opposed shoulders is substantially perpendicular to said second set of opposed shoulders.

12. A seat assembly, comprising:
a seat;
a wall by said seat, said wall including a window;
a seat adjustment switch inboard of said wall;
an actuator, outboard of said wall, connected to said seat adjustment switch; and
a stop adapted to limit displacement of said actuator when said actuator is displaced inboard toward said wall wherein said stop is carried on one of said wall and said actuator.

13. The seat assembly of claim 12, wherein said actuator includes a stem and a knob.

14. The seat assembly of claim 13, wherein said stem has a proximal end connected to said seat adjustment switch and a distal end connected to said knob.

15. The seat assembly of claim 14, wherein said stop is located on said actuator adjacent an intersection of said knob and said stem.

16. The seat assembly of claim 15, wherein said stop comprises (a) a first shoulder and (b) a second shoulder on an opposite side of said stem from said first shoulder.

17. The seat assembly of claim 15, wherein said stop comprises a continuous step extending around said stem.

18. The seat assembly of claim 15, wherein said stop comprises a first set of opposed shoulders and a second set of opposed shoulders wherein said first set of opposed shoulders is substantially perpendicular to said second set of opposed shoulders.

19. The seat assembly of claim 14, wherein said stop is located on said wall adjacent said window.

20. The seat assembly of claim 19, wherein said stop comprises (a) a first shoulder and (b) a second shoulder on an opposite side of said window from said first shoulder.
